(19) United States
(12) Patent Application Publication
(10) Pub. No.: US 2026/0128284 A1
(43) Pub. Date: May 7, 2026

(54) BATTERY ELECTRODE

(71) Applicant: FORD GLOBAL TECHNOLOGIES, LLC, Dearborn, MI (US)

(72) Inventors: Shiran ZHANG, Ann Arbor, MI (US); Michael LERNER, Corvallis, OR (US); Sookyung JEONG, Northville, MI (US)

(21) Appl. No.: 18/940,158

(22) Filed: Nov. 7, 2024

(51) Int. Cl. H01M 4/36; C01B 32/21; H01M 4/02; H01M 4/48; H01M 4/587

(52) U.S. Cl. CPC H01M 4/366; C01B 32/21; H01M 4/48; H01M 4/587; C01P 2004/04; C01P 2004/80; C01P 2006/40; H01M 2004/021; H01M 2004/027

(57) ABSTRACT

A battery includes, in one example, a positive electrode and a negative electrode, where the negative electrode includes active material flakes with hydroxylated edges surrounding non-hydroxylated planes. Hydroxylated metal oxide nanoparticles are chemisorbed to the hydroxylated edges, selectively coating these regions. The metal oxide nanoparticles may be tungsten, niobium, or aluminum.

### TECHNICAL FIELD

This disclosure relates to electrodes for lithium-ion batteries.

### BACKGROUND

Fast charging capability is a factor for practical lithium-ion battery applications, driving ongoing research. Coating anodes may increase the charging speed of lithium-ion batteries.

### SUMMARY

A battery includes a positive electrode and a negative electrode including active material flakes defining hydroxylated edges surrounding non-hydroxylated planes and hydroxylated metal oxide nanoparticles chemisorbed to the hydroxylated edges and selectively coating the hydroxylated edges. The active material flakes may be graphite-based. The metal oxide nanoparticles may be selected from a group that comprises oxides of tungsten, niobium, and aluminum. The metal oxide nanoparticles may be covalently bonded to the hydroxylated edges of the negative electrode. The metal oxide nanoparticles may have an average particle size between 5 nm and 100 nm. The metal oxide nanoparticles may form a uniform coating layer at the hydroxylated edges of the active material flakes. The ring coating may have a thickness between 20 nm and 200 nm.

An electrode assembly includes a current collector, and a graphite-based active material layer, with active material flakes defining hydroxylated edges surrounding non-hydroxylated planes, and metal oxide nanoparticles chemically bonded to the hydroxylated edges of the active material flakes, forming a selective coating around the hydroxylated edges. The metal oxide nanoparticles may be amorphous metal oxides. The metal oxide nanoparticles may be selected from a group of oxides that comprises tungsten, niobium, and aluminum. The non-hydroxylated planes of the graphite-based active material layer may be substantially free of metal oxide nanoparticles. The metal oxide nanoparticles may be covalently bonded to the hydroxylated edges of the graphite-based active material layer. The metal oxide nanoparticles may have an average particle size between 5 nm and 100 nm. The metal oxide nanoparticles may form a continuous layer at the terminal surfaces of the graphite-based active material layer.

A method of forming an electrode material includes applying a hydroxide to a graphite-based active material to form a hydroxide-treated graphite-based active material with hydroxyl groups at edge sites, dispersing the hydroxide-treated graphite-based active material in a non-polar solvent with a metal chloride precursor to form a graphite-based active material solution, adding a metal chloride precursor solution into the graphite-based active material solution, and calcining resulting material collected from the graphite-based active material solution to remove chlorine and form amorphous metal oxide nanoparticles selectively anchored at edge sites of the graphite-based active material. The method may further include drying the hydroxide-treated graphite-based active material in a vacuum to remove water before dispersing in the non-polar solvent. The non-polar solvent may be a hydrocarbon solvent. The metal chloride precursor may be selected from a group that comprises tungsten hexachloride, niobium pentachloride, and aluminum trichloride. The calcining may be performed at 150° C. The method may further include collecting the resulting material using vacuum filtration before calcining.

### BRIEF DESCRIPTION OF THE DRAWINGS

FIG. 1 is a schematic diagram of a conventional electrode coating;

FIGS. 2-3 are images of selective coatings at electrode edges;

FIG. 4 is a schematic diagram of selective coating at electrode edges; and

FIG. 5 is a flowchart of a method to form a ring-coated electrode.

### DETAILED DESCRIPTION

In accordance with the present disclosure, embodiments of electrode structures, manufacturing methods, and battery systems are described herein. These embodiments illustrate innovative techniques for enhancing lithium-ion battery performance by modifying graphite-based active material flakes with hydroxylated edges and incorporating metal oxide nanoparticles, such as those selected from oxides of tungsten, niobium, or aluminum, which chemisorb to the hydroxylated edges.

The figures and descriptions provided are exemplary and do not represent every possible variation or configuration. Certain elements may be emphasized or minimized to clarify specific features of the electrode assemblies and their formation processes. Accordingly, the disclosed structural and functional details are not intended to limit the scope of the invention but to provide guidance to those skilled in the art of implementing various embodiments of the claimed subject matter.

Unless specifically stated otherwise, all numerical values, measurements, percentages, and similar quantitative parameters disclosed should be interpreted as being prefaced with “about.” This includes any figures regarding porosity, particle size, coating thickness, and calcination temperatures. The use of “about” accounts for variations due to measurement techniques, manufacturing conditions, material properties, and inherent performance fluctuations in the electrode structures and battery systems. For instance, a range of “5 to 100 nm” for nanoparticle size should be interpreted as “about 5 to about 100 nm,” encompassing slight deviations that do not materially affect the performance or functionality of the electrode assembly or the battery system as a whole.

Anode coating methods such as mixing and impregnation have limitations as mentioned previously. Mixing in one example can involve combining graphite particles with coating materials, often in the form of polymer binders or conductive additives. This blend is then applied onto the graphite surface, which is later calendared to achieve a dense, cohesive anode layer. While mixing can be straightforward and allows for relatively simple processing, it tends to result in an uneven distribution of the coating material. This occurs because the particles are dispersed somewhat randomly, with minimal control over where the coating adheres, leading to non-uniformity, particularly at the microscale. Consequently, some graphite particles may remain entirely uncoated, while others may exhibit thick, irregular layers.

Impregnation takes a different approach by introducing coating solutions into a pre-existing anode structure, often through capillary action or through soaking methods where the coating material can penetrate into the porous electrode. Typically, this is done using a liquid solution containing conductive or protective materials, such as carbon-based additives or metallic particles, which are introduced under vacuum or by slow infiltration. Coating materials, however, may concentrate on the outer surfaces of the graphite particles or near pore openings.

A coating strategy utilizing surface reactions to achieve selective coating at graphite edges is presented. This method capitalizes on the presence of surface hydroxyl groups at graphite edges, which are absent on the basal plane. These hydroxyl groups may react with moisture-sensitive metal precursors, allowing for the selective anchoring of metal compounds at graphite edges. To heighten this process, the surface hydroxyl density may be increased by treating graphite with a hydroxide base, such as potassium hydroxide. This treatment results in numerous hydroxyl groups forming at the edge sites of graphite particles. The treated graphite is then dispersed in a non-polar solvent, which may be a liquid hydrocarbon. This step maintains a water-free system, confining hydroxyl groups to graphite edges, and it allows for effective dispersion of graphite due to the non-polar nature of its basal plane.

The choice of metal precursor includes moisture-sensitive compounds such as tungsten hexachloride, niobium pentachloride, or aluminum trichloride. These metals, in their oxide forms, may increase the fast-charging capabilities of anodes. Due to their covalent bonding, these metal chlorides may be dissolved in the same non-polar solvent as the graphite. The coating process involves gradually adding the solution containing the metal precursor to the graphite solution. In this controlled environment, the moisture-sensitive precursors react readily with the hydroxyl groups at graphite edges, forming a homogeneous metal oxychloride coating specifically at these sites. A final step involves a mild calcination process in air, which oxidizes the metal chloride, resulting in an amorphous metal oxide coating layer at the graphite edges.

This approach offers several advantages over conventional coating methods. Unlike impregnation or mixing methods that result in random distribution of coating materials on graphite surfaces, this reaction-based approach ensures that coating occurs only at graphite edges where hydroxyl groups are present. This selectivity maximizes the synergy between graphite and fast-charging materials. By avoiding coating on the basal plane, this method prevents the decrease in press density that typically occurs with conventional coating methods. This preservation of the basal plane properties helps maintain the energy density of the anode. The solution-based nature of this reaction allows precursor molecules to access inner graphite edges, ensuring a more thorough and uniform coating throughout the graphite particles.

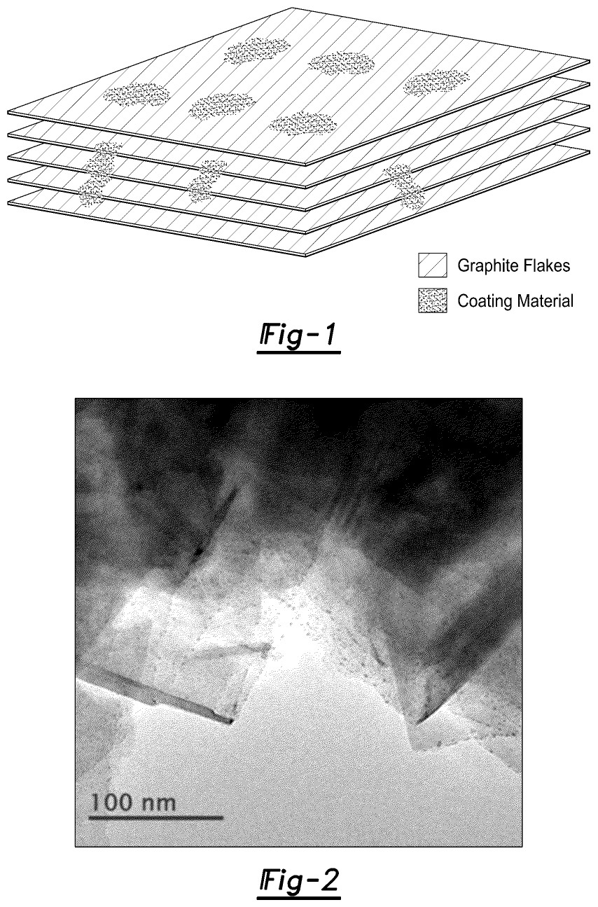

FIG. 1 is a schematic diagram of a conventional electrode coating strategy. The active material graphite flakes are layered on top of each other, with coating material applied irregularly. In this conventional approach, the coating material application results in an uneven distribution across the graphite flakes.

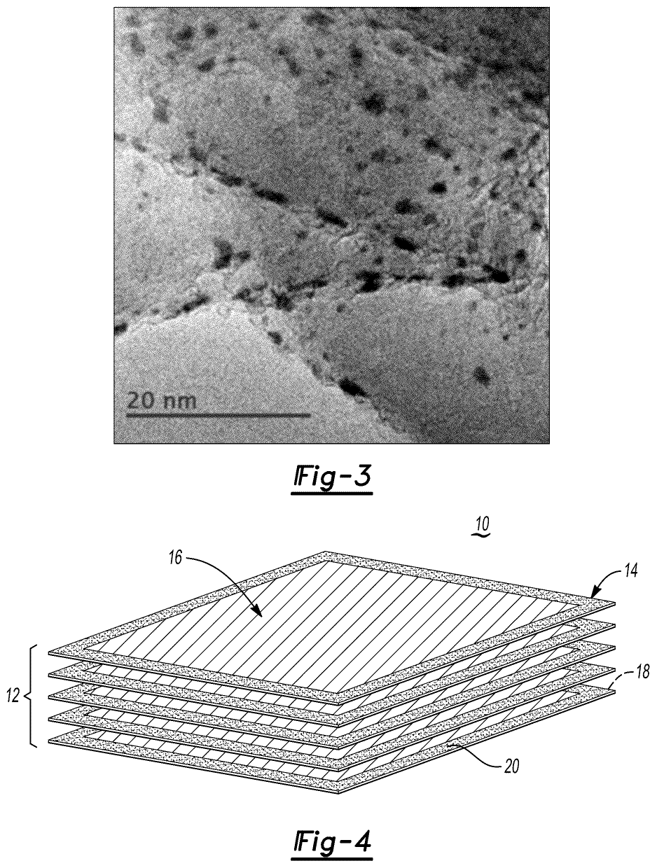

FIGS. 2-3 show transmission electron microscopy images of graphite particles with tungsten trioxide selectively coated at their edges. FIG. 2 shows a broader view at a scale of 100 nm. In this image, the layered structure of graphite particles is visible. The edges of these graphite sheets appear slightly darker and more pronounced, which likely indicates the presence of the tungsten trioxide coating. The coating is applied selectively at the edges and corners of the graphite layers, consistent with the selective edge coating strategy. FIG. 3 is a more magnified view, with a scale of 20 nm, allowing for a closer examination of the edge coating. In this image, the selective nature of the coating becomes more apparent. The edges of the graphite sheets are clearly visible and show a distinct darker contrast compared to the planar surfaces. This darker region along the edges represents the tungsten trioxide coating.

FIG. 4 is a schematic diagram of an electrode assembly 10 with selective coating at the edges. Active material flakes 12, which may be graphite-based, are arranged horizontally on top of each other. Each active material flake 12 has hydroxylated edges 14 which form a continuous perimeter around each active material flake 12 and non-hydroxylated planes 16. Hydroxylated metal oxide nanoparticles 18 are chemisorbed to these hydroxylated edges 14, forming a uniform coating layer 20. This coating layer 20 creates a selectively coated ring-like structure around each active material flake 12, demonstrating a well-controlled deposition process that specifically targets the edge sites. The non-hydroxylated planes 16 remain uncoated. Within the coating layer 20 hydroxylated metal oxide nanoparticles 18 are uniformly distributed along all the hydroxylated edges 14 of the active material flakes 12. The hydroxylated metal oxide nanoparticles 18 covalently bond to the hydroxylated edges 14 due to the presence of reactive hydroxyl groups at these locations. The thickness of the coating layer 20, may be consistent around all edges, typically ranging between 20 nanometers (nm) and 200 nm. The metal oxide nanoparticles 18 themselves have an average particle size between 5 nm and 100 nm.

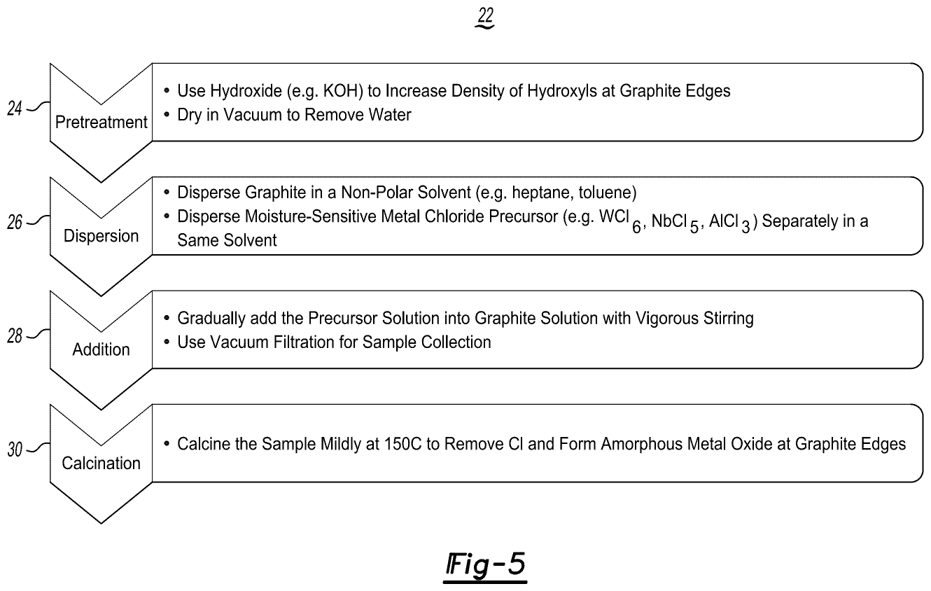

FIG. 5 is a flowchart of a method 22 to form a selectively coated electrode. At pretreatment step 24, hydroxide, such as potassium hydroxide, is used to increase the density of hydroxyl groups at graphite edges. The graphite is then dried in a vacuum to remove water. In the dispersion step 26, graphite is dispersed in a non-polar solvent like heptane or toluene. Separately, a moisture-sensitive metal chloride precursor, such as tungsten hexachloride, niobium pentachloride, or aluminum trichloride. is dispersed in the same type of solvent. The addition step 28 involves gradually adding the precursor solution into the graphite solution with vigorous stirring, followed by vacuum filtration to collect the sample. Finally, in the calcination step 30, the sample is mildly heated at 150° Celsius to remove chlorine and form amorphous metal oxide at the graphite edges. This method 22 results in a selective coating of metal oxide nanoparticles on the edges of graphite particles, creating a ring-coated electrode structure.

Although specific embodiments of the electrode structures, methods of forming such structures, and the resulting battery systems have been described in detail, these examples are not meant to exhaustively cover all possible configurations. The terminology used in this specification is intended to describe, not to limit, the scope of the invention. Modifications and variations can be made without departing from the fundamental inventive concepts described herein. Moreover, the features and elements of the various disclosed embodiments may be combined in unique ways to create additional embodiments within the scope of the claimed subject matter, even if such combinations are not explicitly described in this specification.

What is claimed is:

1. A battery comprising:
a positive electrode; and
a negative electrode including active material flakes defining hydroxylated edges surrounding non-hydroxylated planes, and hydroxylated metal oxide nanoparticles chemisorbed to the hydroxylated edges and selectively coating the hydroxylated edges.

2. The battery of claim 1 wherein the active material flakes are graphite-based.

3. The battery of claim 1 wherein the metal oxide nanoparticles are selected from a group comprising oxides of tungsten, niobium, and aluminum.

4. The battery of claim 1 wherein the metal oxide nanoparticles are covalently bonded to the hydroxylated edges of the negative electrode.

5. The battery of claim 1 wherein the metal oxide nanoparticles have an average particle size between 5 nm and 100 nm.

6. The battery of claim 1 wherein the metal oxide nanoparticles form a uniform coating layer at the hydroxylated edges of the active material flakes.

7. The battery of claim 6 wherein the coating has a thickness between 20 nm and 200 nm.

8. An electrode assembly comprising:
a current collector; and
a graphite-based active material layer, with active material flakes defining hydroxylated edges surrounding non-hydroxylated planes, and metal oxide nanoparticles chemically bonded to the hydroxylated edges of the active material flakes and selectively coating the hydroxylated edges.

9. The electrode assembly of claim 8 wherein the metal oxide nanoparticles are amorphous metal oxides.

10. The electrode assembly of claim 8 wherein the metal oxide nanoparticles are selected from a group comprising oxides of tungsten, niobium, and aluminum.

11. The electrode assembly of claim 8 wherein non-hydroxylated planes of the graphite-based active material layer are free of metal oxide nanoparticles.

12. The electrode assembly of claim 8 wherein the metal oxide nanoparticles are covalently bonded to the hydroxylated edges of the graphite-based active material layer.

13. The electrode assembly of claim 8 wherein the metal oxide nanoparticles have an average particle size between 5 nm and 100 nm.

14. The electrode assembly of claim 8 wherein the metal oxide nanoparticles form a continuous layer at the hydroxylated edges of the graphite-based active material layer.

15. A method of forming an electrode material comprising:
applying a hydroxide to a graphite-based active material to form a hydroxide-treated graphite-based active material with hydroxyl groups at edge sites;
dispersing the hydroxide-treated graphite-based active material in a non-polar solvent with a metal chloride precursor to form a graphite-based active material solution;
adding a metal chloride precursor solution into the graphite-based active material solution; and
calcining resulting material collected from the graphite-based active material solution to remove chlorine and form amorphous metal oxide nanoparticles selectively anchored at edge sites of the graphite-based active material.

16. The method of claim 15, further comprising drying the hydroxide-treated graphite-based active material in a vacuum to remove water before dispersing in the non-polar solvent.

17. The method of claim 15 wherein the non-polar solvent is a hydrocarbon solvent.

18. The method of claim 15 wherein the metal chloride precursor is selected from a group comprising tungsten hexachloride, niobium pentachloride, and aluminum trichloride.

19. The method of claim 15 wherein calcining is performed at 150° C.

20. The method of claim 15, further comprising collecting the resulting material using vacuum filtration before calcining.
